(19) United States
(12) Patent Application Publication
(10) Pub. No.: US 2026/0163195 A1
(43) Pub. Date: Jun. 11, 2026

(54) Battery Assembly

(71) Applicant: SK On Co., Ltd., Seoul (KR)

(72) Inventors: Kang Seok KIM, Daejeon (KR); Ji Hwan KIM, Daejeon (KR); Jeong Beom JANG, Daejeon (KR); Yoon Suk JUNG, Daejeon (KR)

(21) Appl. No.: 19/405,613

(22) Filed: Dec. 2, 2025

(30) Foreign Application Priority Data
Dec. 5, 2024 (KR) 10-2024-0179511

(51) Int. Cl. H01M 50/503; H01M 10/658; H01M 50/204; H01M 50/289; H01M 50/507; H01M 50/521; H01M 50/529

(52) U.S. Cl. CPC H01M 50/503; H01M 10/658; H01M 50/204; H01M 50/289; H01M 50/507; H01M 50/521; H01M 50/529

(57) ABSTRACT

The present disclosure relates to a battery assembly, and a battery assembly according to one embodiment of the present disclosure may include: a cell stack including one or more battery cells; a busbar including one or more busbar units electrically connecting the battery cells; and a busbar frame on which the busbar is seated and having a protrusion portion disposed between the busbar units.

### CROSS-REFERENCE TO RELATED PATENT APPLICATION

The present application claims priority under 35 U.S.C. § 119(a) to Korean patent application number 10-2024-0179511 filed on Dec. 5, 2024, in the Korean Intellectual Property Office, the entire disclosure of which is incorporated by reference herein.

### BACKGROUND OF THE INVENTION

### 1. Field

The present disclosure relates to a battery assembly, and more particularly, to a battery assembly having excellent stability.

### 2. Description of the Related Art

A secondary battery is a battery designed to convert electrical energy into chemical energy for storage and to allow repeated use through charging and discharging. Owing to its economic and eco-friendly characteristics, the secondary battery is utilized in a wide variety of industrial fields. In particular, among secondary batteries, a lithium secondary battery is widely used in various industries, including portable electronic devices that require high energy density.

The operating principle of a lithium secondary battery is an electrochemical oxidation-reduction reaction. That is, electricity is generated by the movement of lithium ions, and the reverse process constitutes charging. In the case of a lithium secondary battery, a phenomenon in which lithium ions move from the anode, through the electrolyte and separator, to the cathode is referred to as discharging, and the reverse process thereof is referred to as charging.

The secondary battery can generate a large amount of heat during charging and discharging. If the heat generated inside is not promptly suppressed, a fire may spread to adjacent battery cells, causing serious damage. Therefore, one of the major challenges is to promptly suppress the heat generated inside the secondary battery and to prevent the propagation of fire.

For high-capacity and high-output characteristics, a plurality of secondary batteries may be grouped to manufacture a battery module or a battery pack. In this case, a fire occurring in any one of the plurality of battery cells may cause the entire battery module or battery pack to burn down. Therefore, it is essential to prevent such a risk.

### SUMMARY OF THE INVENTION

One embodiment of the present disclosure is to provide a battery assembly having excellent stability.

Another embodiment of the present disclosure is to provide a battery assembly with improved thermal stability.

Still another embodiment of the present disclosure is to provide a battery assembly capable of suppressing thermal runaway.

Meanwhile, the battery assembly according to the present disclosure can be widely applied to green technology fields such as electric vehicles, battery charging stations, and energy storage systems (ESS), as well as solar power generation and wind power generation using batteries. In addition, the battery assembly according to the present disclosure can be used in eco-friendly mobility, including electric vehicles and hybrid vehicles, which suppress air pollution and greenhouse gas emissions to prevent climate change.

As a technical means to achieve the technical objects, a battery assembly comprising: a cell stack including one or more battery cells; a busbar including one or more busbar units electrically connecting the battery cells; and a busbar frame on which the busbar is seated and having a protrusion portion disposed between the busbar units.

In one embodiment, the busbar frame having the protrusion portion may be manufactured by injection molding.

In one embodiment, the protrusion portion may be formed of the same material as another region of the busbar frame.

In one embodiment, the protrusion portion may be formed of a material different from that of another region of the busbar frame.

In one embodiment, the protrusion portion may be formed of a material having superior heat resistance to that of another region of the busbar frame.

In one embodiment, the protrusion portion may include at least one selected from the group consisting of mica, Glass Fiber Reinforced Plastic, and Carbon Fiber Reinforced Plastic.

In one embodiment, the battery cell may include a tab portion for electrical connection with the outside, and the busbar frame may include a through-hole through which the tab portion is drawn out.

In one embodiment, the battery cell may include a tab portion for electrical connection with the outside, and the busbar unit may include a slit through which the tab portion is drawn out.

In one embodiment, the battery cell may include a tab portion for electrical connection with the outside, the busbar frame may include a through-hole through which the tab portion is drawn out, and the busbar unit may include a slit, at a position corresponding to the through-hole, through which the tab portion is drawn out.

In one embodiment, the protrusion portion may extend along the direction in which the tab portion is drawn out.

In one embodiment, the protrusion portion may extend from one surface of the busbar frame where the busbar is seated.

In one embodiment, the battery assembly may further include a blocking portion positioned between any two adjacent battery cells.

In one embodiment, the battery assembly may further include a housing that accommodates the cell stack.

In one embodiment, the battery cell may be a pouch-type, prismatic-type, or cylindrical-type battery cell.

As a technical means to achieve the technical objects, a battery assembly comprising: a cell stack including one or more battery cells; a busbar including one or more busbar units electrically connecting the battery cells; and a busbar frame on which the busbar is seated on one surface and having a protrusion portion extended from the one surface in a direction intersecting the stacking direction of the cell stack.

One embodiment of the present disclosure can provide a battery assembly with improved stability.

One embodiment of the present disclosure can provide a battery assembly with enhanced thermal stability.

One embodiment of the present disclosure can delay the occurrence of fire in the battery assembly.

One embodiment of the present disclosure can suppress a busbar short circuit by means of a protrusion portion disposed between busbar units, even when the busbar frame melts and loses its supporting function for the busbar in a thermal runaway situation. Accordingly, additional thermal runaway caused by a busbar short circuit can be suppressed.

One embodiment of the present disclosure can effectively block heat transfer between battery cells when a fire occurs due to an external impact or overheating of the battery cell, thereby delaying the propagation of the fire.

### BRIEF DESCRIPTION OF THE DRAWINGS

FIG. 1 is a perspective view schematically illustrating a battery cell according to one

embodiment of the present disclosure.

FIG. 2 is an exploded perspective view schematically illustrating a battery assembly according to one embodiment of the present disclosure.

FIG. 3 is a diagram schematically illustrating one cross-sectional view of the battery assembly according to one embodiment of the present disclosure.

FIGS. 4 and 5 are diagrams for explaining a coupling structure of a busbar frame and a busbar of the battery assembly according to one embodiment of the present disclosure.

### DETAILED DESCRIPTION

Specific terms used in the present specification are merely for convenience of explanation and are not intended to limit the illustrated embodiments.

For example, expressions such as “same” or “identical” not only indicate a strictly identical state but also include a state in which a tolerance exists or a difference is present within a range that allows the same function to be obtained.

For example, expressions representing relative or absolute arrangements, such as “in a certain direction,” “along a certain direction,” “parallel,” “perpendicular,” “centered,” “concentric,” or “coaxial,” not only indicate strictly such arrangements but also include states in which a displacement occurs relatively within a range of angles or distances that allow the same function to be obtained.

To describe the present disclosure, the following description will be made based on a three-dimensional orthogonal coordinate system defined by mutually orthogonal X-, Y-, and Z-axes. Each axial direction (X-axis direction, Y-axis direction, Z-axis direction) means both extending directions of each axis. The X-, Y-, and Z-directions mentioned below are provided for clarity of explanation of the present disclosure, and it is, of course, possible to define the directions differently depending on where the reference is set.

The use of terms such as “first,” “second,” and “third” preceding elements in the following description is merely to distinguish the corresponding elements from one another, and is unrelated to the order, importance, or hierarchical relationship among the elements. For example, an invention including only a second element without a first element may also be implemented.

The terms used in the present disclosure are intended to describe particular embodiments and are not intended to limit the scope of the claims. As used in the description of the embodiments and the appended claims, the singular forms are intended to include the plural forms as well, unless the context clearly indicates otherwise.

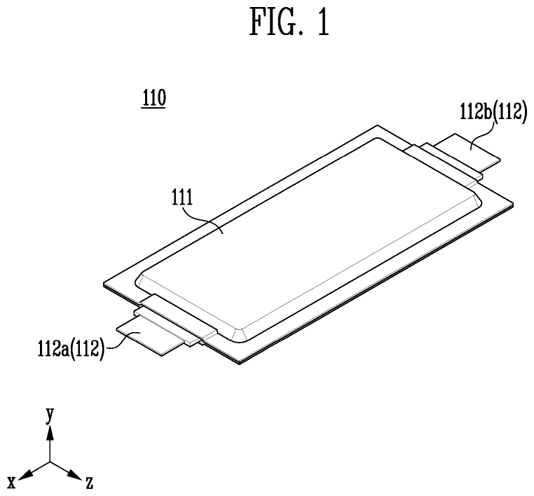

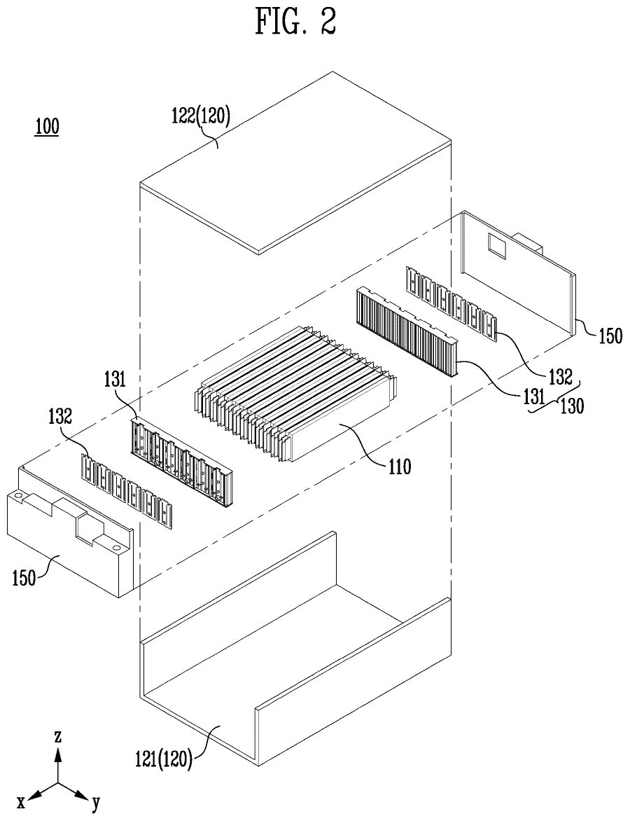

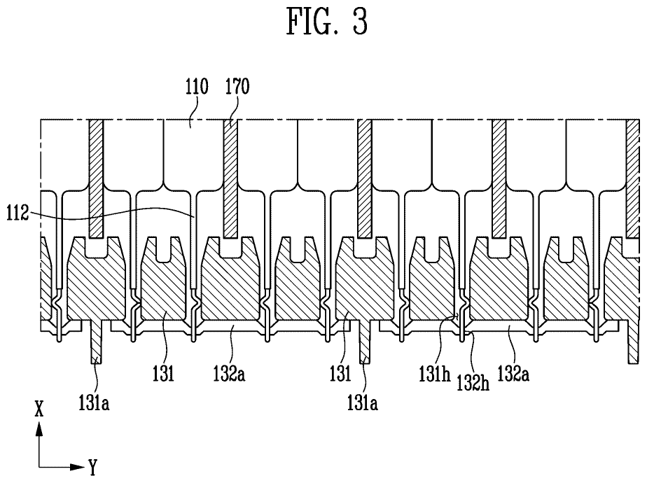

FIG. 1 is a perspective view schematically illustrating a battery cell according to one embodiment of the present disclosure. FIG. 2 is an exploded perspective view schematically illustrating a battery assembly according to one embodiment of the present disclosure. FIG. 3 is a diagram schematically illustrating one cross-sectional view of the battery assembly according to one embodiment of the present disclosure.

Referring to FIGS. 1 to 3, a battery assembly 100 according to one embodiment of the present disclosure may include: a cell stack including one or more battery cells 110; a busbar 132 including one or more busbar units 132a electrically connecting the battery cells 110; and a busbar frame 131 having a protrusion portion 131a disposed between the busbar units 132a while the busbar 132 is seated on one surface thereof.

According to one embodiment of the present disclosure, the battery assembly may be various devices such as a battery module, a battery pack, or an energy storage system (ESS), but is not limited thereto.

The battery cell 110 may refer to a secondary battery capable of being repeatedly used by charging and discharging electrical energy. For example, the battery cell 110 may be a lithium cobalt battery, a lithium high-nickel battery, a lithium iron phosphate battery, a lithium-ion battery, a lithium polymer battery, a lithium-sulfur battery, a nickel-metal hydride battery, a nickel-cadmium battery, a sodium battery, or an all-solid-state battery.

The battery cell 110 may be classified, according to its shape, as a pouch-type secondary battery, a prismatic-type secondary battery, or a cylindrical-type secondary battery. The battery cell 110 may be a pouch-type secondary battery, a prismatic-type secondary battery, or a cylindrical-type secondary battery. In the present specification, for convenience of explanation, a pouch-type secondary battery is illustrated as an example, but the present disclosure is not limited thereto.

Referring to FIG. 1, the battery cell 110 may include a body portion 111 and a tab portion 112. The body portion 111 may store and supply electrical energy. The body portion 111 may include a positive electrode and a negative electrode. For example, the body portion 111 may include an electrode assembly formed by stacking the positive electrode and the negative electrode.

The positive electrode may include a positive electrode active material, and the negative electrode may include a negative electrode active material. The positive electrode active material may be a material capable of inserting and desorbing lithium ions, and the negative electrode active material may be a material capable of absorbing and desorbing lithium ions.

The tab portion 112 may be formed to protrude outward from the body portion 111. The tab portion 112 may be connected respectively to the positive electrode and the negative electrode and may protrude outward from the body portion 111. The tab portion 112 may include a positive electrode tab 112a connected to the positive electrode and a negative electrode tab 112b connected to the negative electrode.

In one embodiment, the positive electrode tab 112a and the negative electrode tab 112b may protrude in opposite directions. For example, referring to FIG. 1, the positive electrode tab 112a may protrude along the +X direction, and the negative electrode tab 112b may protrude along the −X direction.

The tab portion 112 may electrically connect the battery cell to the outside. The tab portion 112 may be connected respectively to the positive electrode and the negative electrode of the body portion 111 to supply the electrical energy stored in the body portion 111 to the outside or to receive electrical energy from the outside.

In one embodiment, the battery assembly 100 may refer to a group of one or more battery cells 110 grouped together to protect the battery cells from external impacts, heat, and vibration, and to achieve high-output and high-capacity characteristics. For example, the battery assembly 100 may refer to a battery module or a battery pack. In the present specification, for convenience of explanation, a battery module is described as an example of the battery assembly 100.

Referring to FIG. 2, in one embodiment, the battery assembly 100 may include a housing 120 that accommodates a cell stack including one or more battery cells 110. This may serve to protect the battery cells 110 from external foreign substances or impacts and to assemble them into a single unit.

The housing 120 may include a receiving body 121 that accommodates a plurality of battery cells 110 and a receiving cover 122 that is coupled to the receiving body 121 to form, together with the receiving body 121, a space in which the plurality of battery cells 110 are accommodated.

The receiving body 121 may include an opening opened upward, and the plurality of battery cells 110 may be accommodated through the opening. The receiving cover 122 may be coupled to the receiving body 121 to close the opening.

In one embodiment, the battery assembly 100 may further include an end cover 150. The end cover 150 may be coupled to both sides of the receiving body 121 to form one side surface of the receiving space. For example, the end cover 150 may be coupled to the receiving body 121 along the X direction.

In one embodiment, the battery assembly 100 may form a hexahedral shape by the housing 120 and the end cover 150. Through this structure, the battery cells 110 positioned inside may be efficiently protected from external impacts.

In one embodiment, the battery assembly 100 may include a busbar assembly 130. The busbar assembly 130 may include a busbar 132 and a busbar frame 131 on which the busbar 132 is seated.

The busbar frame 131 may extend along the direction in which the plurality of battery cells 110 are stacked. The plurality of battery cells 110 may be positioned such that their wide surfaces face each other to improve stacking efficiency. For example, referring to FIG. 2, the plurality of battery cells 110 may be stacked along the Y direction.

The busbar frame 131 may be positioned to face the tab portions 112 of the battery cells 110. The busbar frame 131 may extend along the stacking direction corresponding to the number of stacked battery cells 110, or one or more busbar frames 131 may be provided along the stacking direction corresponding to the number of stacked battery cells 110.

The busbar frame 131 may include a through-hole 131h through which the tab portion 112 of the battery cell 110 is drawn out. The tab portion 112 of the battery cell 110 may be drawn out to one surface of the busbar frame 131 through the through-hole 131h. One surface of the busbar frame 131 may be in a direction opposite to the direction facing the battery cells 110, and the other surface of the busbar frame 131 may be in the direction facing the battery cells 110. In FIG. 2, one surface of the busbar frame 131 may be in the +X direction, and the other surface of the busbar frame 131 may be in the −X direction.

The busbar 132 may be seated on one surface of the busbar frame 131. The busbar 132 may electrically connect the battery cells 110 and may include one or more busbar units 132a.

In one embodiment, the busbar unit 132a may electrically connect adjacent battery cells 110. The plurality of battery cells 110 may be electrically connected in series or in parallel according to the manner in which they are connected to the busbar units 132a.

The busbar unit 132a may include a slit 132h through which the tab portion 112 of the battery cell may be drawn out. The tab portion 112 of the battery cell 110 may be drawn out through the slit 132h. The drawn-out tab portions 112 may be connected to electrically connect the plurality of battery cells 110. The tab portion 112 may be drawn out to one surface of the busbar 132 and may be coupled and connected to another drawn-out portion.

The slit 132h of the busbar unit 132a may be provided at a position corresponding to the through-hole 131h of the busbar frame 131. Accordingly, the tab portion 112 of the battery cell may be directly drawn out to the busbar 132 through the busbar frame 131.

In one embodiment, the busbar frame 131 may have a protrusion portion 131a.

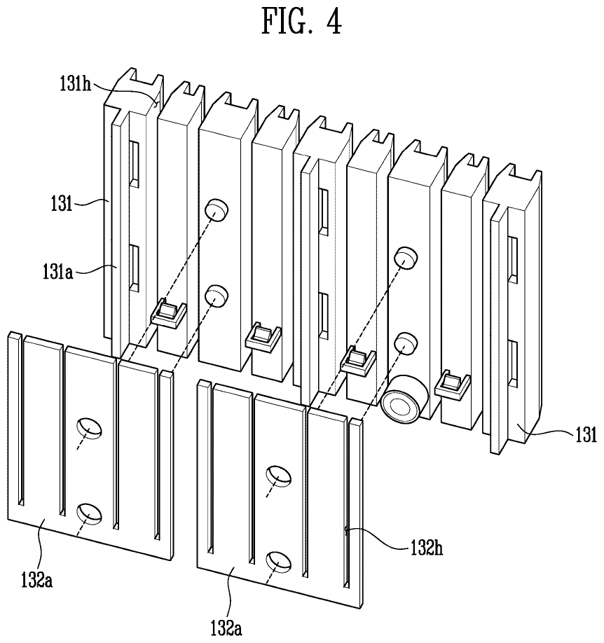

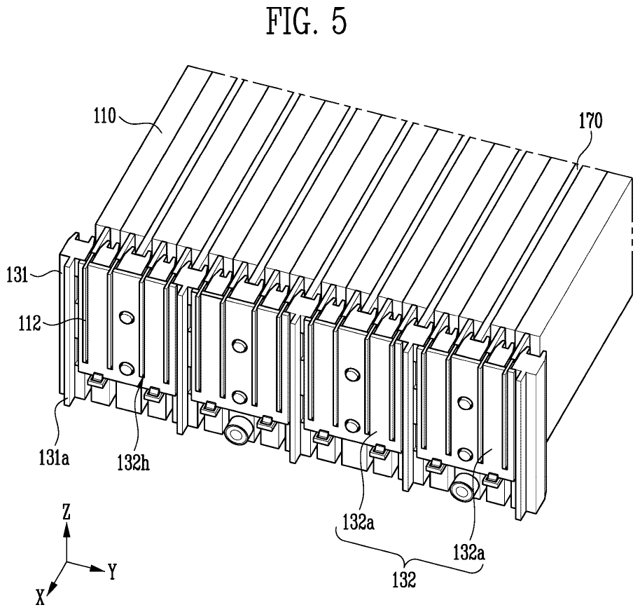

FIGS. 4 and 5 are diagrams for explaining a coupling structure of a busbar frame and a busbar of the battery assembly according to one embodiment of the present disclosure.

Referring to FIGS. 3 to 5, the busbar 132 may be seated on one surface of the busbar frame 131, and a protrusion portion 131a may be inserted between the busbar units 132a that are seated.

In one embodiment, the protrusion portion 131a may protrude from one surface of the busbar frame 131 by a predetermined length.

In one embodiment, the busbar frame 131 may extend along the direction (Y direction) in which the plurality of battery cells 110 are stacked, and the busbar units 132a may also be arranged along the direction in which the plurality of battery cells 110 are stacked. In one embodiment, the busbar frame 131 may include a plurality of protrusion portions 131a formed along the direction in which the battery cells 110 are stacked.

In one embodiment, one protrusion portion 131a may be disposed between the busbar units 132a and may be formed in the direction in which the slits of the busbar units 132a are formed.

That is, one protrusion portion 131a may be formed in a direction perpendicular to the stacking direction of the battery cells (Z direction).

The adjacent busbar units 132a may be prevented from contacting each other by the protrusion portion 131a of the busbar frame 131.

In one embodiment, the busbar frame 131 having the protrusion portion 131a may be manufactured by an injection molding.

In one embodiment, the protrusion portion 131a may not be a separate structure from the busbar frame 131, but may be an integrated single structure with the busbar frame 131.

In one embodiment, the protrusion portion 131a may be formed of the same material as another region of the busbar frame 131. Alternatively, the protrusion portion 131a may be formed of a material different from that of another region of the busbar frame 131.

In one embodiment, the busbar frame 131 may be manufactured of a flame-retardant plastic material.

In one embodiment, the busbar frame 131 may be made of a highly heat-resistant material that does not melt under high-temperature and high-pressure conditions. In particular, it may be made of a material that maintains its shape under thermal runaway conditions (high temperature and high pressure), and a material that maintains its shape at a temperature of 100° C. or higher, 120° C. or higher, 150° C. or higher, or 200° C. or higher may be used. Without being limited thereto, examples of such materials may include MICA, GFRP (Glass Fiber Reinforced Plastic), and CFRP (Carbon Fiber Reinforced Plastic).

In one embodiment, the protrusion portion 131a may be made of a material having superior heat resistance to that of another region of the busbar frame 131.

In one embodiment, when the protrusion portion 131a is formed of a material different from that of another region of the busbar frame 131, it may be manufactured by an insert injection molding method.

In one embodiment, the busbar frame 131, particularly the protrusion portion 131a, may withstand a high-temperature and high-pressure environment during a thermal runaway situation and maintain its shape. Accordingly, it may maintain the spacing between the busbar units 132a.

Even if the busbar frame 131 is made of a flame-retardant material, the temperature during thermal runaway may exceed the melting point of the busbar frame 131. When the busbar frame 131 melts, the supporting function of the busbar 132 may be lost. If the supporting function of the busbar 132 is lost, contact may occur between the busbar units 132a, thereby causing a busbar short circuit. The busbar short circuit under thermal runaway conditions may generate additional thermal runaway, thereby accelerating the thermal runaway.

However, according to one embodiment of the present disclosure, even if the busbar frame 131 loses its supporting function for the busbar 132 during a thermal runaway situation, a busbar short circuit can be suppressed by the protrusion portion 131a disposed between the busbar units 132a.

In one embodiment, the busbar frame 131 may have excellent assemblability due to having the protrusion portion 131a.

Since the protrusion portion 131a protrudes from one surface of the busbar frame 131, it may not interfere with drawing the tab portion 112 of the battery cell to one surface of the busbar frame 131 and the busbar 132.

In addition, when the busbar unit 132a is disposed between the protrusion portions 131a of the busbar frame 131 during assembly of the battery assembly, the busbar 132 may be easily fixed to the busbar frame 131. Accordingly, the subsequent coupling process of the tab portions 112 of the battery cells may also be easily performed.

In one embodiment, the protrusion portion 131a may not affect the arrangement of the battery cells disposed inside the housing, thereby having a low assembly difficulty and a high degree of design freedom.

In one embodiment, the battery assembly 100 may include a blocking portion 170. The blocking portion 170 may be disposed between the plurality of battery cells 110. The blocking portion 170 may be stacked together with the plurality of battery cells 110 along the direction in which the plurality of battery cells 110 are stacked. In one embodiment, the blocking portion 170 may be positioned between two adjacent battery cells 110. The blocking portion 170 may be formed of a flame-retardant material to prevent the propagation of fire between the battery cells.

As described above, even if the busbar frame 131 melts and loses its supporting function for the busbar 132 during a thermal runaway situation, the battery assembly according to one embodiment may suppress a busbar short circuit by means of the protrusion portion 131a disposed between the busbar units 132a. Accordingly, additional thermal runaway caused by a busbar short circuit can be suppressed.

One embodiment of the present disclosure may be a battery pack including one or more battery modules. The configuration and characteristics of the battery module are as described above. The battery pack may further include, in addition to the battery module, a pack case for accommodating the battery module and various devices for controlling the charging and discharging of the battery module, for example, a battery management system (BMS), a current sensor, and a fuse.

The present disclosure may be implemented in various forms, and therefore, the scope of the present disclosure is not limited to the embodiments described above. Accordingly, if a modified embodiment includes the components of the claims of the present disclosure, it should be construed as falling within the scope of the present disclosure.

What is claimed is:

1. A battery assembly comprising:
a cell stack including one or more battery cells;
a busbar including one or more busbar units electrically connecting the battery cells; and
a busbar frame on which the busbar is seated and having a protrusion portion disposed between the busbar units.

2. The battery assembly according to claim 1, wherein the busbar frame having the protrusion portion is manufactured by injection molding.

3. The battery assembly according to claim 1, wherein the protrusion portion is formed of the same material as another region of the busbar frame.

4. The battery assembly according to claim 1, wherein the protrusion portion is formed of a material different from that of another region of the busbar frame.

5. The battery assembly according to claim 1, wherein the protrusion portion is formed of a material having superior heat resistance to that of another region of the busbar frame.

6. The battery assembly according to claim 1, wherein the protrusion portion includes at least one selected from the group consisting of mica, Glass Fiber Reinforced Plastic, and Carbon Fiber Reinforced Plastic.

7. The battery assembly according to claim 1, wherein the battery cell includes a tab portion for electrical connection with the outside, and the busbar frame includes a through-hole through which the tab portion is drawn out.

8. The battery assembly according to claim 1, wherein the battery cell includes a tab portion for electrical connection with the outside, and the busbar unit includes a slit through which the tab portion is drawn out.

9. The battery assembly according to claim 1, wherein the battery cell includes a tab portion for electrical connection with the outside,
the busbar frame includes a through-hole through which the tab portion is drawn out, and
the busbar unit includes a slit, at a position corresponding to the through-hole, through which the tab portion is drawn out.

10. The battery assembly according to claim 9, wherein the protrusion portion extends along the direction in which the tab portion is drawn out.

11. The battery assembly according to claim 10, wherein the protrusion portion extends from one surface of the busbar frame where the busbar is seated.

12. The battery assembly according to claim 1, further comprising a blocking portion positioned between any two adjacent battery cells.

13. The battery assembly according to claim 1, further comprising a housing that accommodates the cell stack.

14. The battery assembly according to claim 1, wherein the battery cell is a pouch-type, prismatic-type, or cylindrical-type battery cell.

15. A battery assembly comprising:
a cell stack including one or more battery cells;
a busbar including one or more busbar units electrically connecting the battery cells; and
a busbar frame on which the busbar is seated on one surface and having a protrusion portion extended from the one surface in a direction intersecting the stacking direction of the cell stack.
